(19) United States
(12) Patent Application Publication
(10) Pub. No.: US 2022/0309834 A1
(43) Pub. Date: Sep. 29, 2022

(54) SKELETON RECOGNITION METHOD, COMPUTER-READABLE RECORDING MEDIUM STORING SKELETON RECOGNITION PROGRAM, AND ARTISTIC GYMNASTICS SCORING SUPPORT APPARATUS

(71) Applicant: FUJITSU LIMITED, Kawasaki-shi (JP)

(72) Inventors: Hiroshi Ikeda, Kawasaki (JP); Ryo Murakami, Kawasaki (JP)

(73) Assignee: FUJITSU LIMITED, Kawasaki-shi (JP)

(21) Appl. No.: 17/700,763

(22) Filed: Mar. 22, 2022

(30) Foreign Application Priority Data
Mar. 29, 2021 (JP) 2021-055639

(51) Int. Cl. G06V 40/20; G06T 7/521; G06T 7/73

(52) U.S. Cl. CPC G06V 40/23; G06T 7/521; G06T 7/73; G06V 40/28; G06T 2207/10028; G06T 2207/30196; G06T 2207/30221

(57) ABSTRACT

A skeleton recognition method includes: obtaining an integrated three-dimensional point cloud by integrating three-dimensional point clouds obtained by detecting a target person and a target object from a plurality of directions with a plurality of detection devices; and recognizing skeleton information of the target person by optimizing, based on the integrated three-dimensional point cloud and a three-dimensional model that represents the target person and the target object that is in contact with the target person, an objective function that represents matching between coordinates of the integrated three-dimensional point cloud and surface coordinates of the three-dimensional model and by obtaining a joint angle of the target person. The objective function is a first objective function that includes a function based on a distance between a hand end of the target person and the target object.

### CROSS-REFERENCE TO RELATED APPLICATION

This application is based upon and claims the benefit of priority of the prior Japanese Patent Application No. 2021-55639, filed on Mar. 29, 2021, the entire contents of which are incorporated herein by reference.

### FIELD

The embodiment discussed herein is related to a skeleton recognition method, a computer-readable recording medium storing a skeleton recognition program, and an artistic gymnastics scoring support apparatus.

### BACKGROUND

A skeleton recognition technique is a technique for identifying positions of joints of a human body from information of a point cloud that is a plurality of points on a surface of the human body obtained from three-dimensional sensors. A human body model, which is a geometric model, is fitted to the point cloud, and positions of joints in the human body model are determined. The term “fitting” refers to optimizing an objective function that represents a degree of agreement between the point cloud and the human body model. The optimization is implemented by minimizing a distance between the point cloud and the human body model.

Masui Shoichi et al., “Practical Implementation of Gymnastics Scoring Support System based on 3D Sensing and Skill Recognition Technology (3D Senshingu-Waza Ninshiki Gijutsu ni yoru Taiso Saiten Shien Shisutemu no Jitsuyoka)”, [online], 2020, Information Processing, [Searched on Mar. 18, 2021], Internet (URL: https://www.ipsj.or.jp/dp/contents/publication/44/S1104-S01.html) is disclosed as related art.

### SUMMARY

According to an aspect of the embodiments, a skeleton recognition method includes: obtaining, by a computer, an integrated three-dimensional point cloud by integrating three-dimensional point clouds obtained by detecting a target person and a target object from a plurality of directions with a plurality of detection devices; and recognizing skeleton information of the target person by optimizing, based on the integrated three-dimensional point cloud and a three-dimensional model that represents the target person and the target object that is in contact with the target person, an objective function that represents matching between coordinates of the integrated three-dimensional point cloud and surface coordinates of the three-dimensional model and by obtaining a joint angle of the target person. The objective function is a first objective function that includes a function based on a distance between a hand end of the target person and the target object in a case where the distance between the hand end of the target person and the target object is less than or equal to a certain length.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration of an artistic gymnastics scoring support apparatus;

FIG. 2 is a schematic diagram for describing an integrated three-dimensional point cloud of a target person;

FIG. 3 is a schematic diagram for describing an arrangement of detection devices;

FIG. 4 is a schematic diagram for describing fitting of the integrated three-dimensional point cloud of the target person and a three-dimensional model;

FIG. 5 is a schematic diagram for describing a three-dimensional model of the target person and a target object;

FIG. 6 is a schematic diagram for describing a multi-angle view;

FIG. 7 is a schematic diagram for describing a skill recognition view;

FIG. 8 is a schematic diagram for describing an environment in which judges perform scoring by using scoring support apparatuses;

FIG. 9 is a block diagram illustrating a functional configuration of a contact recognition adjustment unit;

FIG. 10 is a schematic diagram for describing a contact recognition adjustment process;

FIG. 11 is a schematic diagram for describing a distance between a hand end of an athlete and a bar member;

FIG. 12 is a schematic diagram for describing a measurement error;

FIG. 13 is a schematic diagram for describing a measurement error;

FIG. 14 is a block diagram illustrating a hardware configuration of the artistic gymnastics scoring support apparatus;

FIG. 15 is a flowchart illustrating an example of a flow of an artistic gymnastics scoring support process; and

FIG. 16 is a flowchart illustrating an example of a flow of a contact recognition adjustment process.

### DESCRIPTION OF EMBODIMENTS

With the current skeleton recognition technique, although a hand end of a target person and a target object are actually in contact with each other, it may be recognized that they are not in contact with each other in some cases.

In one aspect, it is an object of the present disclosure to improve the accuracy of recognition of a contact between a hand end of a target person and a target object.

### Functional Configuration

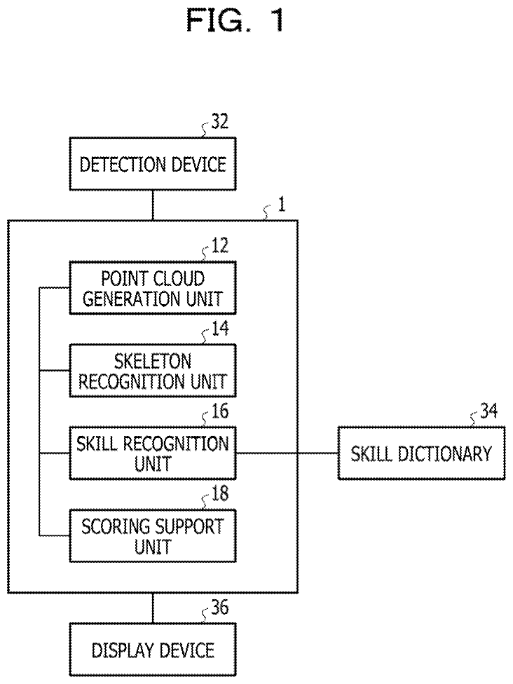

FIG. 1 illustrates a functional configuration diagram of an artistic gymnastics scoring support apparatus 1. The artistic gymnastics scoring support apparatus 1 includes a point cloud generation unit 12, a skeleton recognition unit 14, a skill recognition unit 16, and a scoring support unit 18.

By using a plurality of detection devices 32, the point cloud generation unit 12 measures distances from the detection devices 32 to a target person and to a target object and generates depth images. The detection devices 32 may be, for example, three-dimensional laser sensors. The three-dimensional laser sensors may be Micro Electro Mechanical Systems (MEMS) mirror type laser sensors that employ Light Detection and Ranging (LiDAR) technology. The target person may be, for example, a gymnast. The target object may be, for example, a gymnastics apparatus. In the present embodiment, the gymnastics apparatus is a horizontal bar.

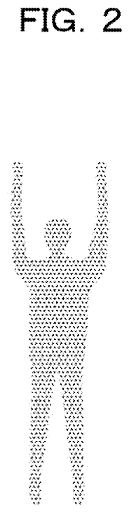

Based on time periods from when a laser pulse is projected from a light projecting unit of each of the plurality of detection devices 32 to when reflected light reflected by the target person and reflected light reflected by the target object are received by a light-receiving unit, the point cloud generation unit 12 measures distances to the target person and to the target object and generates a depth image. The point cloud generation unit 12 generates three-dimensional point clouds from the respective depth images each generated using a corresponding one of the plurality of detection devices 32, and by integrating the generated three-dimensional point clouds, generates an integrated three-dimensional point cloud. FIG. 2 illustrates an integrated three-dimensional point cloud of the target person.

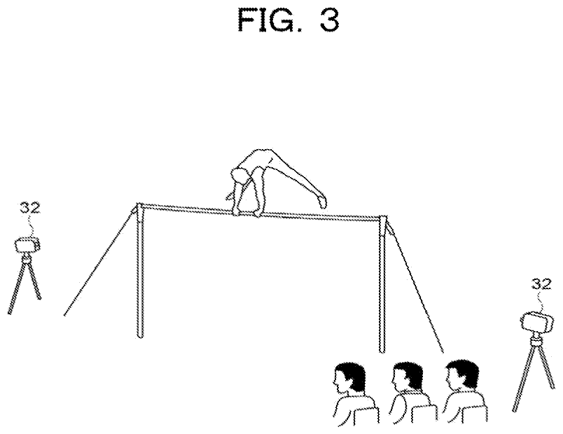

To obtain multi-viewpoint depth images of the target person and the target object, the plurality of detection devices 32 are used as illustrated in FIG. 3. However, FIG. 1 illustrates one detection device 32 to make the description simple. FIG. 3 illustrates two detection devices 32. However, three or more detection devices may be appropriately installed so that an event, viewing, judging, or the like is not disturbed.

By combining, for example, skeleton recognition and fitting, the skeleton recognition unit 14 extracts three-dimensional coordinates of each joint that constitutes the human body, from the integrated three-dimensional point cloud generated by the point cloud generation unit 12. In skeleton recognition, the three-dimensional skeleton coordinates are inferred by using, for example, a trained inference model. The inference model may be created on, for example, a convolutional-neural-network-based (CNN-based) deep learning network.

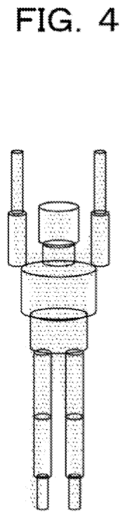

In fitting, by using a result of fitting in the previous frame or the like as an initial value, a three-dimensional model that represents the target person and the target object is applied to the integrated three-dimensional point cloud generated by the point cloud generation unit 12. By defining an objective function that represents a likelihood representing a degree of matching between coordinates of the integrated three-dimensional point cloud and surface coordinates of the three-dimensional model and by determining joint angles with the highest likelihood through optimization, three-dimensional skeleton coordinates are determined. In the example in FIG. 4, a human body model, which is a three-dimensional model that represents the target person, is applied to the integrated three-dimensional point cloud of the target person.

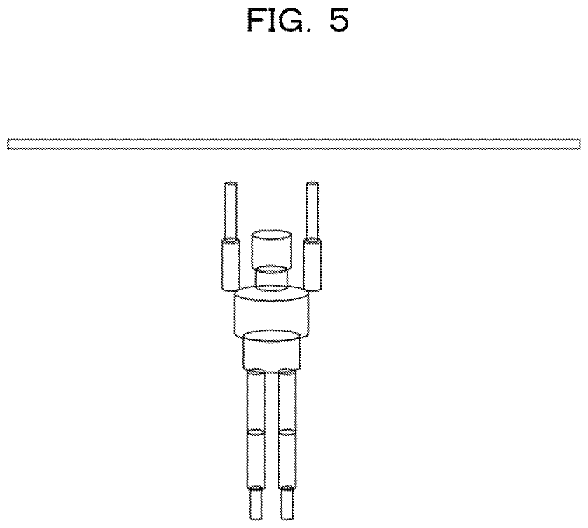

As illustrated in FIG. 5, the human body model is constituted by a circular cylinder, an elliptical cylinder, and the like. The length and the radius of the circular cylinder and the length, the major axis, the minor axis, and so on of the elliptical cylinder are optimized in advance in accordance with the body type of the target person. For example, in a horizontal bar event, a bar member of the horizontal bar is also observed as a point cloud by the detection devices 32. Thus, a three-dimensional model obtained by adding the three-dimensional model of the target object to the three-dimensional model of the target person, for example, by adding the three-dimensional model of the bar member to the three-dimensional model of the human body is used.

Because there is a state in which the target person and the target object are not in contact with each other, a model in which the three-dimensional model of the human body and the three-dimensional model of the bar member are not coupled to each other is used. The expression “be in contact” refers to a state in which the target person and the target object are coupled to each other, and encompasses, for example, a state in which the target person is gripping the target object.

The skill recognition unit 16 recognizes a break between basic moves from time-series data of the three-dimensional skeleton coordinates, which is a result of the fitting, and determines a feature quantity and a basic move for each divisional piece of the time-series data. The break between basic moves, the feature quantity, the basic moves, and the like are determined based on rules or through machine learning. The skill recognition unit 16 recognizes basic skills by using, as a parameter, the feature quantity related to the basic moves, and recognizes skill information subjected to scoring by comparing the consecutive basic skills with a skill dictionary 34, which is a database created in advance.

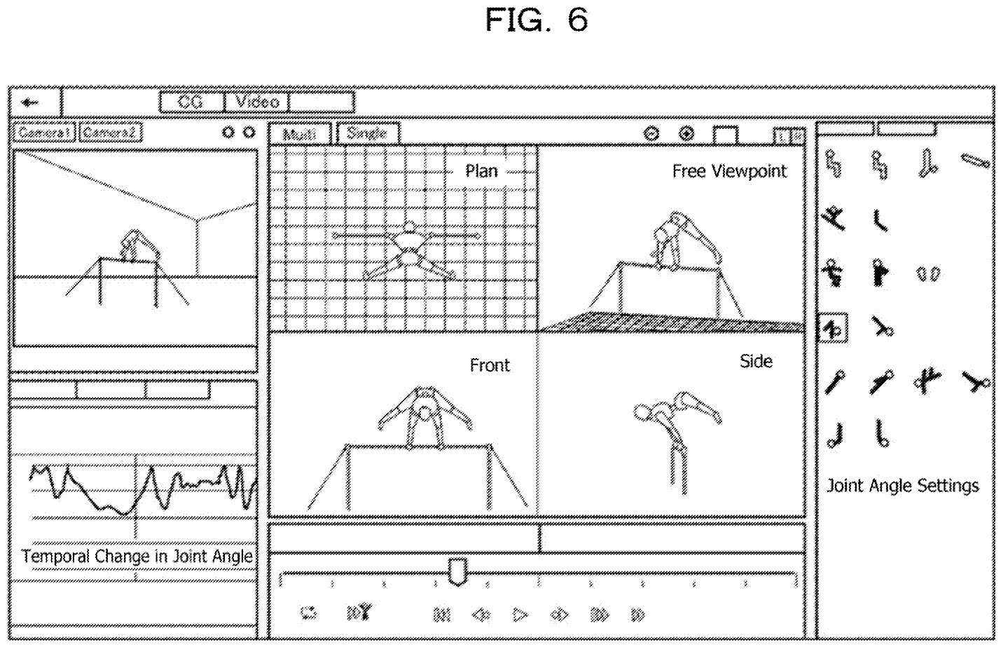

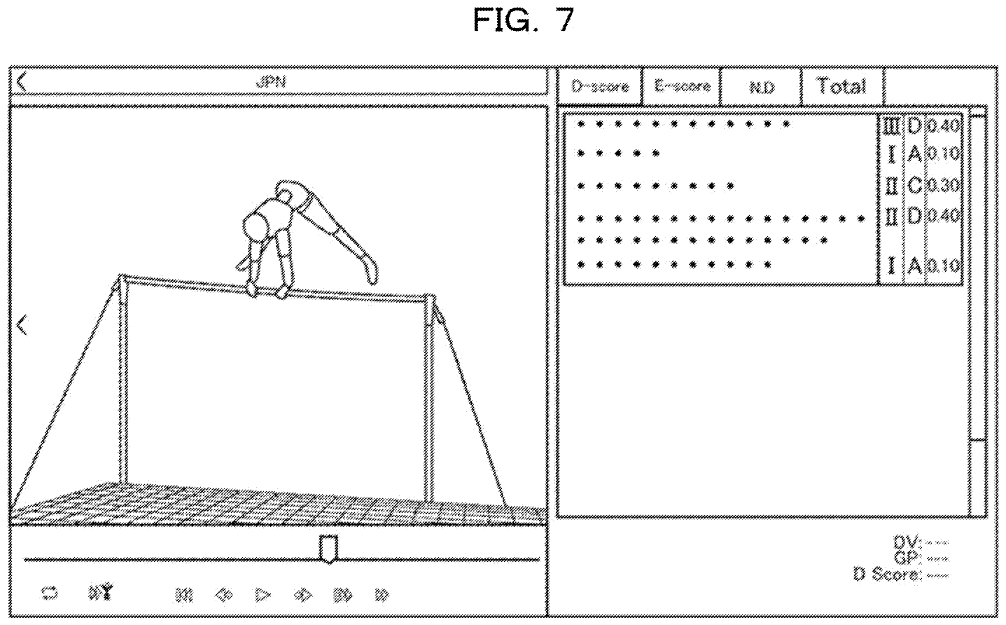

The scoring support unit 18 generates, for example, a multi-angle view illustrated in FIG. 6, a skill recognition view illustrated in FIG. 7, and the like from the three-dimensional skeleton coordinates obtained by the skeleton recognition unit 14 and the skill information recognized by the skill recognition unit 16, and displays these views on a display device 36. In the multi-angle view, for example, the joint angles or the like may be checked in detail for each frame in the performance of an athlete. In the skill recognition view, the name or the like of a skill obtained based on the skill recognition result is presented for each demonstrated skill. The scoring support unit 18 performs scoring by using the three-dimensional skeleton coordinates, based on scoring rules defined based on bending angles of the joints determined by the three-dimensional coordinate positions, and displays a scoring result on the display device 36.

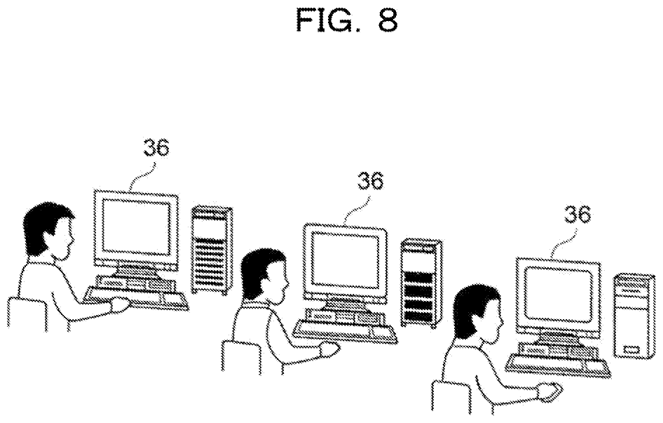

In the multi-angle view, the three-dimensional skeleton coordinates may be displayed from viewpoints such as front, side, and plan, for example. In the skill recognition view, for example, the time-series skill recognition result, the group number of the skill, the difficulty of the skill, the difficulty value point, the score indicating the difficulty of all the demonstrated skills, and the like may be displayed. As illustrated in FIG. 8, judges may perform scoring by referring to scoring support information, such as the multi-angle view, the skill recognition view, and the scoring result obtained by the scoring support unit 18, displayed on the display device 36.

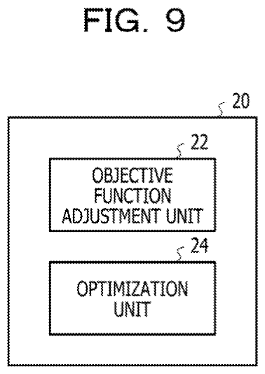

FIG. 9 illustrates a functional configuration of a contact recognition adjustment unit 20 included in the skeleton recognition unit 14. The contact recognition adjustment unit 20 adjusts an error caused in measurement of a distance between the target person and the target object. The contact recognition adjustment unit 20 includes an objective function adjustment unit 22 and an optimization unit 24.

The objective function adjustment unit 22 initializes the objective function to an objective function equivalent to a second objective function represented, for example, by Equation (1). Equation that represents the degree of agreement between the integrated three-dimensional point cloud and the three-dimensional model (degree of agreement between point cloud and model) may be determined based on an existing technique.

Objective function=(Degree of agreement between point cloud and model) (1)

When a distance d1 between the target object and a hand end of the left hand of the target person is less than or equal to a certain length, the objective function adjustment unit 22 adds a function f(d1) based on the distance between the target object and the hand end of the left hand of the target person to the initialized objective function as represented by Equation (2). In this manner, the objective function adjustment unit 22 adjusts the objective function to an objective function equivalent to a first objective function. This is done for adjusting a measurement error because of which it is determined that the target object and the hand end of the left hand are not in contact with each other despite the fact that they are in contact with each other.

Objective function=(Degree of agreement between point cloud and model)+f(d1) (2)

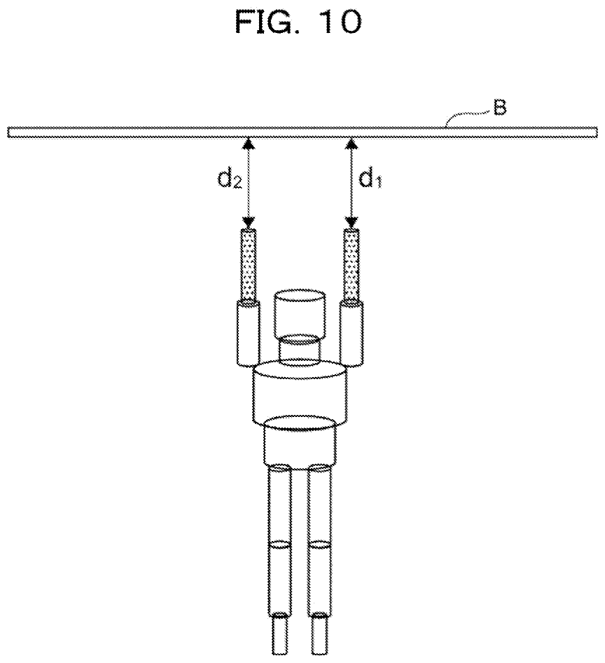

In the case of a horizontal bar event, for example, a measurement error because of which it is determined that a bar member is not gripped by the left hand of the athlete despite the fact that the bar member is gripped by the left hand of the athlete is adjusted. FIG. 10 illustrates the distance d1 between a bar member B and the hand end of the left hand of the athlete.

When a distance d2 between the target object and a hand end of the right hand of the target person is less than or equal to the certain length, the objective function adjustment unit 22 adds a function f(d2) based on the distance between the target object and the hand end of the right hand of the target person to the initialized objective function as represented by Equation (3). In this manner, the objective function adjustment unit 22 adjusts the objective function to an objective function equivalent to the first objective function. This is done for correcting a measurement error because of which it is determined that the target object and the hand end of the right hand are not in contact with each other despite the fact they are in contact with each other.

Objective function=(Degree of agreement between point cloud and model)+f(d2) (3)

In the case of the horizontal bar event, for example, a measurement error because of which it is determined that the bar member is not gripped by the right hand of the athlete despite the fact that the bar member is gripped by the right hand of the athlete is corrected. FIG. 10 illustrates the distance d2 between the bar member B and the hand end of the right hand of the athlete.

When the distance d1 between the target object and the hand end of the left hand of the target person and the distance d2 between the target object and the hand end of the right hand of the target person are less than or equal to the certain length, the objective function adjustment unit 22 adds the function f(d1) and the function f(d2) to the initialized objective function as represented by Equation (4). In this manner, the objective function adjustment unit 22 adjusts the objective function to an objective function equivalent to the first objective function. This is done for adjusting a measurement error because of which it is determined that the target object and the hand ends of both hands are not in contact with each other despite the fact they are in contact with each other. In the case of the horizontal bar event, for example, a measurement error because of which it is determined that the bar member is not gripped by both hands of the athlete despite the fact that the bar member is gripped by both hands of the athlete is adjusted.

Objective function=(Degree of agreement between point cloud and model)+f(d1)+f(d2) (4)

Let d denote a distance between the bar member B and a hand end H of an athlete. Then, a function f(d) based on the distance d between the bar member B and the hand end H may be calculated using Equation (5) as an example.

f(d)=d²=h·h(h·e)² (5)

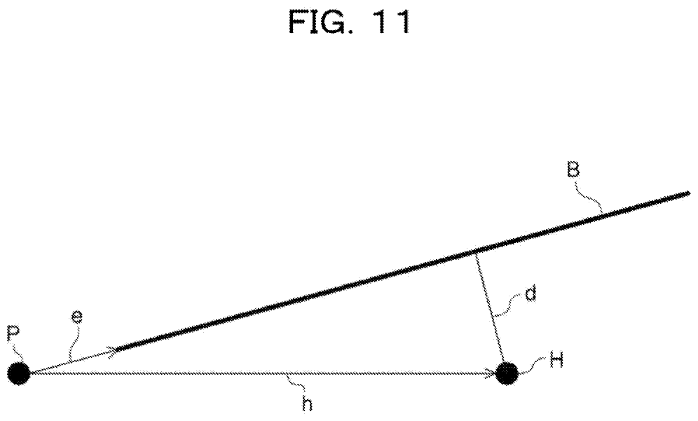

As illustrated in FIG. 11, “e” denotes a unit vector whose length along the model of the bar member B is equal to 1, and “h” denotes a vector extending from the start point of the vector “e” toward the hand end H. “hh” denotes an inner product of the vector “h”, and “he” denotes an inner product of the vector “h” and the vector “e”. As for the model of the bar member B, a segment of the bar member may be modeled as a straight line segment in consideration of bending or the like of the bar member.

By performing fitting for applying the three-dimensional model to the three-dimensional point cloud and by determining, with the adjusted objective function, joint angles with the highest likelihood through optimization, the optimization unit 24 determines the three-dimensional skeleton coordinates.

When the distance d1 between the target object and the hand end of the left hand of the target person exceeds the certain length and the distance d2 between the target object and the hand end of the right hand of the target person exceeds the certain length, the objective function adjustment unit 22 does not adjust the initialized objective function represented by Equation (1). By performing fitting for applying the three-dimensional model to the three-dimensional point cloud and by determining, with the not-adjusted objective function, joint angles with the highest likelihood through optimization, the optimization unit 24 determines the three-dimensional skeleton coordinates.

In the present embodiment, the accuracy of recognition of a contact may be improved by adjusting the objective function when the distance between the hand end of the target person and the target object is small, for example, is less than or equal to the certain length. For example, the certain length may be 20 cm to 30 cm.

In the present embodiment, for each hand of the left hand and the right hand, the objective function is adjusted by adding the function based on the distance between the target object and the hand end of the target person when the distance between the target object and the hand end of the target person is less than or equal to the certain length. Thus, the objective function may be applied in any of the case where the hand end of any one of the hands is in contact with the target object, the case where both hand ends are in contact with the target object, and the case where neither hand ends are in contact with the target object. For example, the objective function may be applied in any of the case where the bar member is gripped by the athlete with the hand end of any one of the hands, the case where the bar member is gripped with both hand ends, and the case where the bar member is gripped with neither hand ends.

The detection devices 32 project laser onto the target person and the target object. When only part of a spot, which is a cross section of the laser, hits the target person or the target object, the remaining part of the spot hits a different object located at a position farther than the target object from the detection devices 32. As a result, the target person and the target object may be recognized to be located farther than the actual distances from the detection devices 32 in some cases.

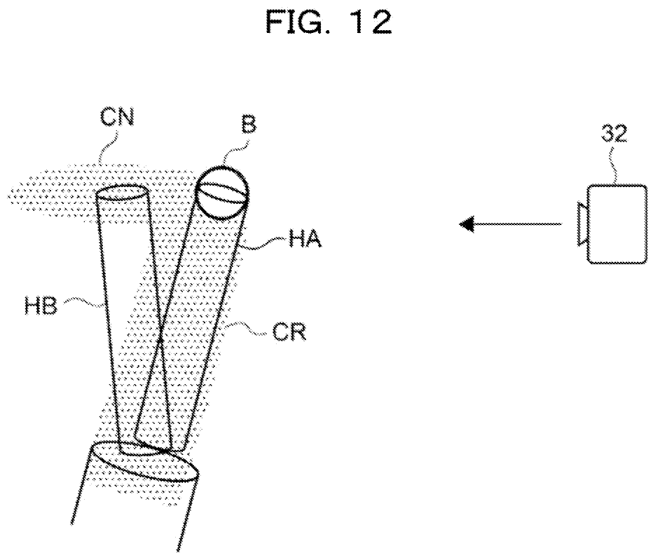

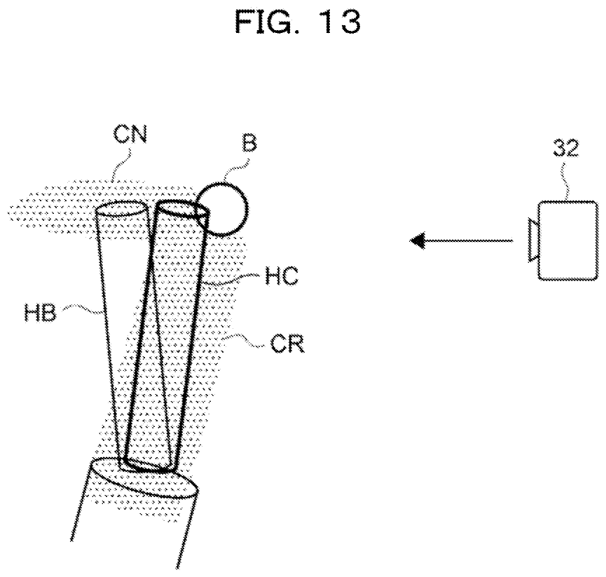

For example, as illustrated in FIG. 12, even if a hand end HA is in contact with the bar member B, a false point cloud CN due to the above-described phenomenon appears in addition to a point cloud CR of the hand end HA and the bar member B as a result of detection performed by the detection devices 32. In accordance with optimization of the not-adjusted objective function, the position of the hand end HA is erroneously recognized to be a position of a hand end HB that is not gripping the bar member B. According to the present embodiment, as illustrated in FIG. 13, an influence of the false point cloud CN may be reduced. Thus, the position of the hand end HA is recognized to be a position of a hand end HC instead of the hand end HB. Consequently, the hand end HC is recognized to be in contact with the bar member B.

### Hardware Configuration

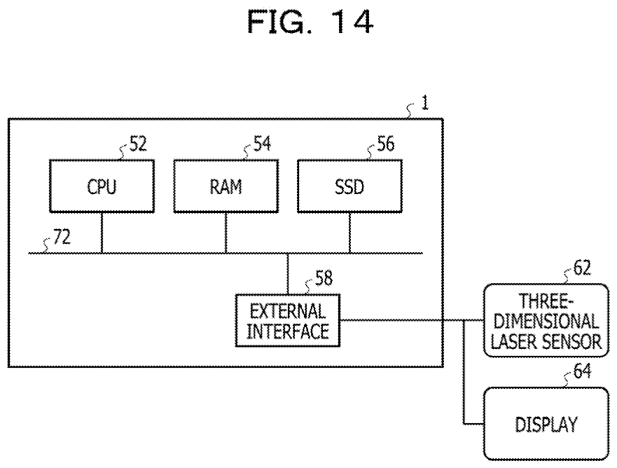

FIG. 14 illustrates a hardware configuration of the artistic gymnastics scoring support apparatus 1. The artistic gymnastics scoring support apparatus 1 includes a central processing unit (CPU) 52, a random-access memory (RAM) 54, a solid-state drive (SSD) 56, and an external interface 58 as an example.

The CPU 52 is an example of a processor that is hardware. The CPU 52, the RAM 54, the SSD 56, and the external interface 58 are coupled to each other through a bus 72. The CPU 52 may be a single processor or may be a plurality of processors. In place of the CPU 52, for example, a graphics processing unit (GPU) may be used.

The RAM 54 is a volatile memory and is an example of a primary storage device. The SSD 56 is a nonvolatile memory and is an example of a secondary storage device. The secondary storage device may be a hard disk drive (HDD) or the like in addition to or instead of the SSD 56.

The secondary storage device includes a program storage area, a data storage area, and so on. The program storage area stores a program such as an artistic gymnastics scoring support program as an example. The data storage area may store, for example, three-dimensional point cloud data, a skill dictionary, artistic gymnastics scoring results, and so on.

By loading the program such as the artistic gymnastics scoring support program from the program storage area and executing the program through the RAM 54, the CPU 52 operates as the point cloud generation unit 12, the skeleton recognition unit 14, the skill recognition unit 16, and the scoring support unit 18 illustrated in FIG. 1. The artistic gymnastics scoring support program includes a contact recognition adjustment program as a part thereof. The CPU 52 operates as the contact recognition adjustment unit 20 included in the skeleton recognition unit 14, for example, as the objective function adjustment unit 22 and the optimization unit 24 that are included in the contact recognition adjustment unit 20.

The program such as the artistic gymnastics scoring support program may be stored in an external server and may be loaded by the CPU 52 via a network. The program such as the artistic gymnastics scoring support program may be recorded on a non-transitory recording medium such as a Digital Versatile Disc (DVD) and may be loaded by the CPU 52 through a recording medium reading device.

An external device is coupled to the external interface 58. The external interface 58 is responsible for transmission and reception of various kinds of information between the external device and the CPU 52. FIG. 14 illustrates an example in which a three-dimensional laser sensor 62, which is an example of the detection device 32, and a display 64, which is an example of the display device 36, are coupled to the external interface 58. For example, a communication device, an external storage device, or the like may be coupled to the external interface 58. The artistic gymnastics scoring support apparatus 1 may be a personal computer, a server, or the like, or may be on-premise or cloud-based.

### Artistic Gymnastics Scoring Support Process

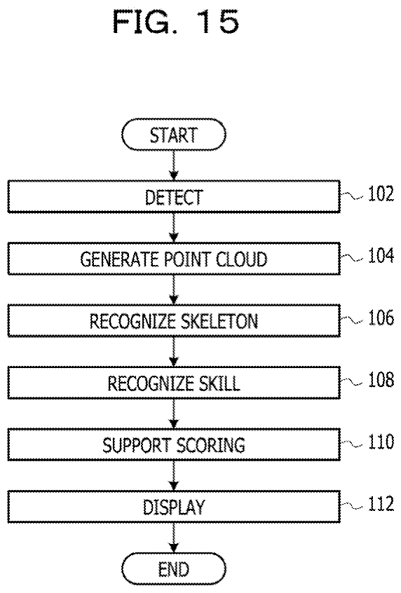

FIG. 15 illustrates a flow of an artistic gymnastics scoring support process. In step 102, the CPU 52 detects an athlete and a gymnastics apparatus by using each of the plurality of three-dimensional laser sensors 62. In step 104, the CPU 52 generates three-dimensional point clouds from depth images each obtained by a corresponding one of the plurality of three-dimensional laser sensors 62, integrates the generated three-dimensional point clouds, and generates an integrated three-dimensional point cloud. In step 106, the CPU 52 extracts three-dimensional coordinates of each joint that constitutes the human body from the integrated three-dimensional point cloud, and applies a three-dimensional model of the athlete and the gymnastics apparatus to the integrated three-dimensional point cloud.

By defining an objective function that represents a likelihood representing a degree of matching between coordinates of the integrated three-dimensional point cloud and surface coordinates of the three-dimensional model of the athlete and by determining, through optimization, joint angles with the highest likelihood, the CPU 52 determines three-dimensional skeleton coordinates. In step 108, the CPU 52 recognizes basic skills from time-series data of the three-dimensional skeleton coordinates obtained in step 106, and recognizes skills subjected to scoring by comparing the skills with the skill dictionary 34 in time series. In step 110, the CPU 52 performs scoring by using the skill recognition result or the like obtained in step 108. In step 112, the CPU 52 displays, on the display 64, the multi-angle view, the skill recognition view, and the like for supporting a judge in scoring.

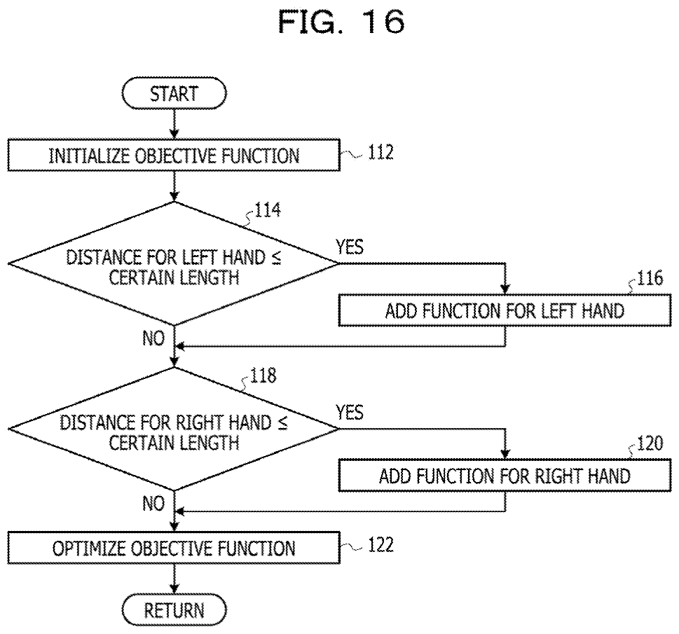

FIG. 16 illustrates a flow of a contact recognition adjustment process that is a part of a skeleton recognition process in step 106. In step 112, the CPU 52 initializes the objective function in a manner as represented, for example, by Equation (1) described above.

In step 114, the CPU 52 determines whether or not a distance between the bar member and the hand end of the left hand in the integrated three-dimensional point cloud of the previous frame obtained by the three-dimensional laser sensors 62 is less than or equal to a certain length. If the determination in step 114 is positive, the CPU 52 adjusts the objective function by adding a function based on the distance between the bar member and the hand end of the left hand to the objective function as represented, for example, by Equation (2). If the determination in step 114 is negative, the objective function is not adjusted.

In step 118, the CPU 52 determines whether or not a distance between the bar member and the hand end of the right hand in the previous frame is less than or equal to the certain length. If the determination in step 118 is positive, the CPU 52 adds a function based on the distance between the bar member and the hand end of the right hand to the objective function as represented, for example, by Equation (3) or Equation (4). If the determination in step 114 is negative and the determination in step 118 is positive, the objective function is adjusted as represented, for example, by Equation (3). If the determination in step 114 and the determination in step 118 are positive, the objective function is adjusted as represented, for example, by Equation (4).

If the determination in step 114 and the determination in step 118 are negative, the objective function is not adjusted. In step 122, the GPU 52 determines the three-dimensional skeleton coordinates of the athlete by optimizing the objective function that is adjusted or not adjusted in steps 114 to 120. The processing in steps 112 to 122 is applied to each frame obtained by the three-dimensional laser sensors 62.

The present embodiment is not limited to the scoring support apparatus for the horizontal bar event of gymnastics, and may be applied to scoring support and training support of various sports. The present embodiment may be applied to creation of entertainment materials such as movies, skill analysis in handicrafts or the like, training support, and so on.

The present embodiment is not limited to improvement of the accuracy of recognition of a contact between a hand end of a target person and a target object. For example, the present embodiment may be applied to improvement of the accuracy of recognition of a contact between a foot end of a target person and a target object, improvement of the accuracy of recognition of a contact between hand ends of a target person, improvement of the accuracy of recognition of a contact between hand ends of two or more target persons, and so on.

In the present embodiment, an integrated three-dimensional point cloud is obtained by integrating three-dimensional point clouds obtained by detecting a target person and a target object that is in contact with the target person from a plurality of directions with a plurality of detection devices. Skeleton information of the target person is recognized by optimizing, based on the integrated three-dimensional point cloud and a three-dimensional model that represents the target person and the target object, an objective function that represents matching between coordinates of the integrated three-dimensional point cloud and surface coordinates of the three-dimensional model and by obtaining a joint angle of the target person. The skeleton information of the target person is recognized by performing optimization using, as the objective function, a first objective function that includes a function based on a distance between a hand end of the target person and the target object in a case where the distance between the hand end of the target person and the target object is less than or equal to a certain length.

According to the present embodiment, the accuracy of recognition of a contact between a hand end of a target person and a target object may be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A skeleton recognition method comprising:
obtaining, by a computer, an integrated three-dimensional point cloud by integrating three-dimensional point clouds obtained by detecting a target person and a target object from a plurality of directions with a plurality of detection devices; and
recognizing skeleton information of the target person by optimizing, based on the integrated three-dimensional point cloud and a three-dimensional model that represents the target person and the target object that is in contact with the target person, an objective function that represents matching between coordinates of the integrated three-dimensional point cloud and surface coordinates of the three-dimensional model and by obtaining a joint angle of the target person, wherein
the objective function is a first objective function that includes a function based on a distance between a hand end of the target person and the target object in a case where the distance between the hand end of the target person and the target object is less than or equal to a certain length.

2. The skeleton recognition method according to claim 1, wherein
the skeleton information of the target person is recognized by performing optimization using, as the objective function, a second objective function that does not include the function based on the distance between the hand end of the target person and the target object in a case where the distance between the hand end of the target person and the target object exceeds the certain length.

3. The skeleton recognition method according to claim 1, wherein
the first objective function in a case where a distance between a hand end of a left hand of the target person and the target object is less than or equal to the certain length is an objective function that includes a function based on the distance between the hand end of the left hand of the target person and the target object, and
the first objective function in a case where a distance between a hand end of a right hand of the target person and the target object is less than or equal to the certain length is an objective function that includes a function based on the distance between the hand end of the right hand of the target person and the target object.

4. The skeleton recognition method according to claim 1, wherein
the detection devices are three-dimensional laser sensors.

5. The skeleton recognition method according to claim 1, wherein
the target person is a gymnast, and
the target object is a gymnastics apparatus.

6. The skeleton recognition method according to claim 5, wherein
the gymnastics apparatus is a bar member of a horizontal bar.

7. The skeleton recognition method according to claim 5, wherein
scoring support information that is related to a gymnastics skill obtained based on the recognized skeleton information is displayed on a display device.

8. A non-transitory computer-readable recording medium storing a skeleton recognition program causing a computer to execute a processing, the processing comprising:
obtaining an integrated three-dimensional point cloud by integrating three-dimensional point clouds obtained by detecting a target person and a target object from a plurality of directions with a plurality of detection devices; and
recognizing skeleton information of the target person by optimizing, based on the integrated three-dimensional point cloud and a three-dimensional model that represents the target person and the target object that is in contact with the target person, an objective function that represents matching between coordinates of the integrated three-dimensional point cloud and surface coordinates of the three-dimensional model and by obtaining a joint angle of the target person, wherein
the objective function is a first objective function that includes a function based on a distance between a hand end of the target person and the target object in a case where the distance between the hand end of the target person and the target object is less than or equal to a certain length.

9. The non-transitory computer-readable recording medium according to claim 8, wherein
the skeleton information of the target person is recognized by performing optimization using, as the objective function, a second objective function that does not include the function based on the distance between the hand end of the target person and the target object in a case where the distance between the hand end of the target person and the target object exceeds the certain length.

10. The non-transitory computer-readable recording medium according to claim 8, wherein
the first objective function in a case where a distance between a hand end of a left hand of the target person and the target object is less than or equal to the certain length is an objective function that includes a function based on the distance between the hand end of the left hand of the target person and the target object, and
the first objective function in a case where a distance between a hand end of a right hand of the target person and the target object is less than or equal to the certain length is an objective function that includes a function based on the distance between the hand end of the right hand of the target person and the target object.

11. The non-transitory computer-readable recording medium according to claim 8, wherein
the detection devices are three-dimensional laser sensors.

12. An information processing apparatus comprising:
a memory; and
a processor coupled to the memory and configured to:
obtain an integrated three-dimensional point cloud by integrating three-dimensional point clouds obtained by detecting a target person and a target object from a plurality of directions with a plurality of detection devices; and
recognize skeleton information of the target person by optimizing, based on the integrated three-dimensional point cloud and a three-dimensional model that represents the target person and the target object that is in contact with the target person, an objective function that represents matching between coordinates of the integrated three-dimensional point cloud and surface coordinates of the three-dimensional model and by obtaining a joint angle of the target person,
wherein the objective function is a first objective function that includes a function based on a distance between a hand end of the target person and the target object in a case where the distance between the hand end of the target person and the target object is less than or equal to a certain length.

13. The information processing apparatus according to claim 12, wherein
the skeleton information of the target person is recognized by performing optimization using, as the objective function, a second objective function that does not include the function based on the distance between the hand end of the target person and the target object in a case where the distance between the hand end of the target person and the target object exceeds the certain length.

14. The information processing apparatus according to claim 12, wherein
the first objective function in a case where a distance between a hand end of a left hand of the target person and the target object is less than or equal to the certain length is an objective function that includes a function based on the distance between the hand end of the left hand of the target person and the target object, and
the first objective function in a case where a distance between a hand end of a right hand of the target person and the target object is less than or equal to the certain length is an objective function that includes a function based on the distance between the hand end of the right hand of the target person and the target object.

15. The information processing apparatus according to claim 12, wherein
the detection devices are three-dimensional laser sensors.
